(19) United States
(12) Patent Application Publication
(10) Pub. No.: US 2009/0033830 A1
(43) Pub. Date: Feb. 5, 2009

(54) OPTICAL SHEET

(76) Inventors: Yaw-Huei TSAI, Taipei County (TW); Ming-Hsuan Liu, Taipei County (TW); Yi-Rong Qiu, Taipei County (TW)

Correspondence Address: BIRCH STEWART KOLASCH & BIRCH, PO BOX 747, FALLS CHURCH, VA, 22040-0747, US

(21) Appl. No.: 11/959,174

(22) Filed: Dec. 18, 2007

(30) Foreign Application Priority Data
Aug. 3, 2007 (TW) 096128548

(51) Int. Cl. G02F 1/1335

(52) U.S. Cl. 349/64

(57) ABSTRACT

An optical sheet includes a substrate and a plurality of convex lens structures. The substrate has a first surface and a second surface, which are disposed opposite to each other. The convex lens structures are disposed on the second surface, and each of the convex lens structure has a cambered surface. The cambered surface fits a curve surface equation of Ax²+By²+Cxy+Dx+Ey+F=0, wherein x and y are variables and A, B, C, D, E and F are constants.

### CROSS REFERENCE TO RELATED APPLICATIONS

This Non-provisional application claims priority under 35 U.S.C. §119(a) on Patent Application No(s). 096128548 filed in Taiwan, Republic of China on Aug. 3, 2007, the entire contents of which are hereby incorporated by reference.

### BACKGROUND OF THE INVENTION

1. Field of Invention

The invention relates to an optical sheet and, in particular, to an optical sheet with diffusion and brightness enhancement functions.

2. Related Art

To increase the visual quality of the liquid crystal display (LCD), it requires high intensity, wide viewing angle, and uniform brightness. The backlight module and its optical sheet are key components to providing sufficient brightness and homogeneous light.

As shown in FIG. 1, a conventional backlight module 1 includes a light source 10, a light guide plate 11, and an optical sheet set 12. The backlight module 1 is a side-edge backlight module. The light source 10 can be a cold cathode fluorescent lamp (CCFL) or several light-emitting diodes (LEDs).

The optical sheet set 12 includes in sequence a lower diffusion sheet 121, a first prism sheet 122, a second prism sheet 123, and an upper diffusion sheet 124 stacked together. The optical sheet set 12 is disposed on the light guide plate 11.

The light (not shown) emitted by the light source 10 enters the light guide plate 11, and then the mesh points on the bottom surface of the light guide plate 11 destroy the total reflection of the incident light. The light then enters the optical sheet set 12. In the optical sheet set 12, the light firstly passes through the lower diffusion sheet 121 for preliminary diffusion. Then, the light passes through the first prism sheet 122 and the second prism sheet 123 to increase its brightness. Finally, the upper diffusion sheet 124 further diffuses the outgoing light, thereby providing the surface light for the LCD panel.

FIG. 2 shows the relation between the luminance and viewing angle after the light passes through a conventional prism sheet. In the conventional prism sheet, to increase the luminance at small viewing angles, the light emitted by the light source is largely attenuated in its luminance around ±45 degrees. Since the attenuation is very large, the user clearly experiences a sudden drop in the luminance when viewing around 45 degrees. Besides, the light between ±45 degrees and ±90 degrees has a cut off effect. Therefore, the user feels that the luminance at large viewing angles becomes suddenly larger than that at the 45 degrees. Moreover, the light at large viewing angles cannot increase the luminance at small viewing angles. This reduces the light usage of the conventional prism sheet at small viewing angles. Since the conventional prism sheet has sharp ends, it is easily broken under an external force, which may affect the optical effect.

Therefore, it is important subject to provide an optical sheet that can increase the luminance of the LCD at small viewing angles as well as reduce the cut off effect at large viewing angles.

### SUMMARY OF THE INVENTION

In view of the foregoing, the invention is to provide an optical sheet that can increase the luminance at small viewing angles as well as reduce the cut off effect at large viewing angles.

In addition, the invention is also to provide an optical sheet that can avoid broken peaks.

To achieve the above, the invention discloses an optical sheet including a substrate and a plurality of convex lens structures. The substrate has a first surface and a second surface, which are disposed opposite to each other. The convex lens structures are disposed on the second surface, and each of the convex lens structure has a cambered surface. The cambered surface fits a curve surface equation of Ax²+By²+Cxy+Dx+Ey+F=0, wherein x and y are variables and A, B, C, D, E and F are constants.

In summary, the optical sheet of the invention has convex lens structures with cambered surfaces formed on the substrate. Compared with the prior art, the optical sheet achieves the effects of converging light to increase the central luminance as well as scattering light at large viewing angles. Such features avoid the cut off effect and large variation in the luminance from small to large viewing angles. The convex lens structures with cambered surfaces also render the optical sheet scratch-proof, thereby avoiding the problem of broken lens peaks.

### BRIEF DESCRIPTION OF THE DRAWINGS

The invention will become more fully understood from the detailed description and accompanying drawings, which are given for illustration only, and thus are not limitative of the present invention, and wherein:

FIG. 1 is a schematic view of a conventional backlight module and its optical sheet;

FIG. 2 shows the relation between the luminance and the viewing angle for a conventional prism sheet;

FIG. 3 is a schematic view of an optical sheet according to a first embodiment of the invention;

FIG. 4 shows the relation between the luminance and the viewing angle for the optical sheet of the invention;

FIG. 5 is a schematic view of another optical sheet according to the first embodiment of the invention;

FIG. 6 is a schematic view of still another optical sheet according to the first embodiment of the invention;

FIG. 7 is a schematic view of an optical sheet according to a second embodiment of the invention;

FIG. 8 is a schematic view of an optical sheet according to a third embodiment of the invention;

FIG. 9 is a schematic view of another optical sheet according to the third embodiment of the invention; and

FIG. 10 is a schematic view of an optical sheet according to a fourth embodiment of the invention.

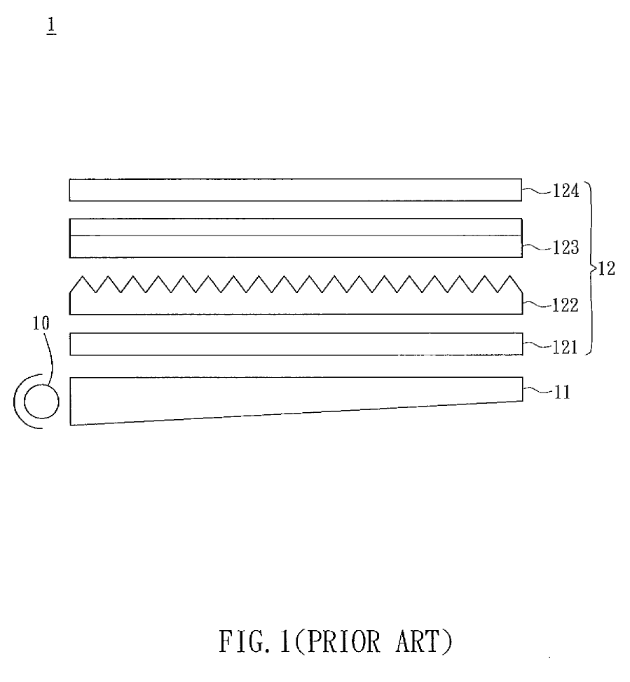

### DETAILED DESCRIPTION OF THE INVENTION

The present invention will be apparent from the following detailed description, which proceeds with reference to the accompanying drawings, wherein the same references relate to the same elements.

### First Embodiment

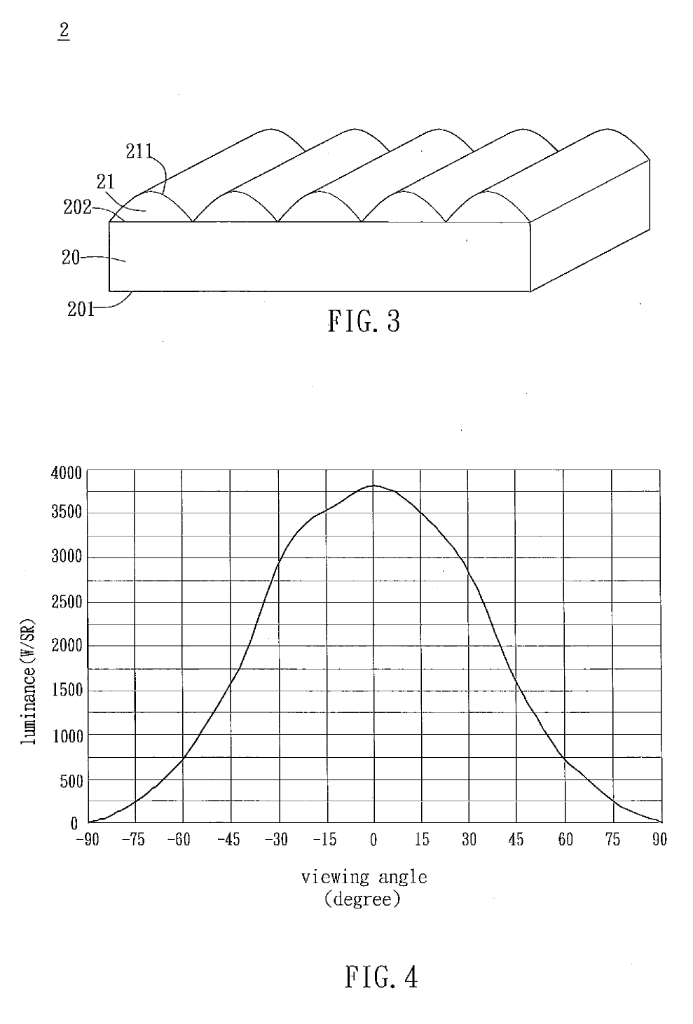

With reference to FIG. 3, an optical sheet 2 according to a first embodiment of the invention includes a substrate 20 and a plurality of convex lens structures 21. In the embodiment, the optical sheet 2 is applied to, for example, the backlight module of a liquid crystal display (LCD).

The substrate 20 has a first surface 201 and a second surface 202 disposed opposite to each other. The material of the substrate 20 is polyethylene terephthalate, PET or polycarbonate.

The convex lens structures 21 are disposed in parallel on the second surface 202 of the substrate 20. Each convex lens structure 21 has a cambered surface 211 that satisfies the curved surface equation Ax²+By²+Cxy+Dx+Ey+F=0. In the above equation, x and y are variables and the coefficients A, B, C, D, B, and F are constants. In particular, the coefficients A and B cannot be simultaneously zero. In the embodiment, A=1, E=1, and B=C=D=F=0, so that the curved surface equation will be x²+y=0. Thus, the cambered surface 211 of the convex lens structure 21 is formed according to the curved surface equation x²+y=0. The height and width between the convex lens structures 21 are the same. Alternatively, the curved surface equation for the convex lens structures 21 can be an ellipse or a circle,

When light passes through the optical sheet 2, it enters via the substrate 20 and leaves through the convex lens structures 21.. The convex lens structures 21 have the functions of diffusing and converging light. The ends of the convex lens structures 21 are cambered surfaces. This not only achieves a better diffusion effect, but also prevents the convex lens structures 21 from being broken by external forces. The convex lens structures 21 are thus scratch-proof.

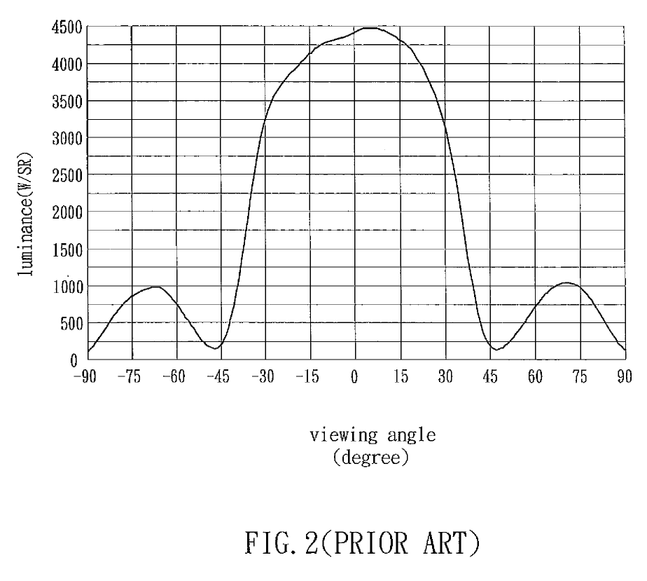

FIG. 4 shows the relation between the luminance and the viewing angle after the light passes through the optical sheet 2. As shown in FIG. 4, even though the luminance of the optical sheet 2 at small angles (e.g., 0 degree) is slightly smaller than that of the conventional prism sheet (FIG. 2), it still enhances the luminance at small viewing angles. Moreover, not only does the optical sheet 2 have a larger luminance at ±45 degrees than the prior art, the luminance varies slowly from small angles to large angles. This can reduce user's discomfort and avoid the cut off effect.

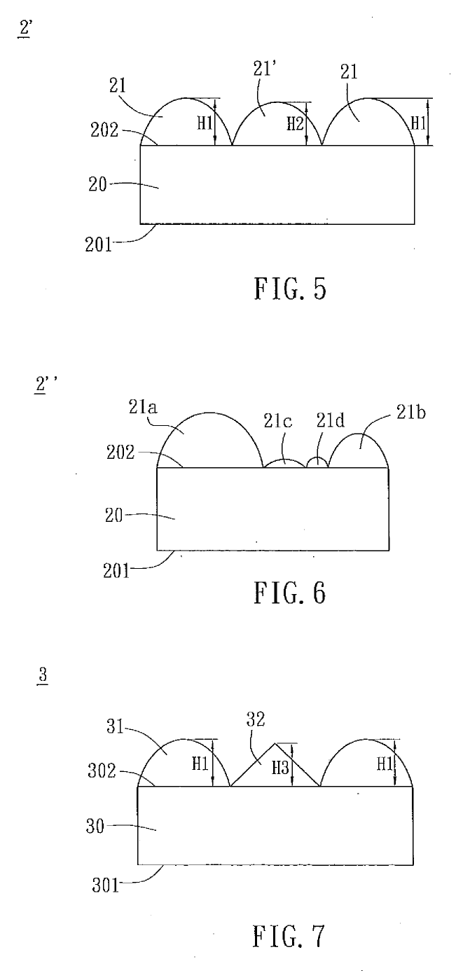

As shown in FIG. 5, another optical sheet 2′ according to the first embodiment of the invention includes a substrate 20 and a plurality of convex lens structures 21, 21′. The difference between the optical sheet 2′ and the above-mentioned optical sheet 2 is in that: the heights H1, H2 of the convex lens structures 21, 21′, respectively, are different, but the curved surface equations are the same. In this embodiment, the convex lens structures are disposed on the second surface 202 of the substrate 20 in the pattern of 21, 21′, and 21 as a cycle. The height H2 of the convex lens structure 21′ in the middle is smaller than the height H1 of the convex lens structures 21 on its both sides.

FIG. 6 shows still another optical sheet 2″ according to the first embodiment of the invention. The optical sheet 2″ includes a substrate 20 and a plurality of convex lens structures 21a, 21b, 21c, 21d. The difference between the optical sheet 2″ and the above-mentioned optical sheet 2 is in that: the height and width of the convex lens structures 21a, 21b, 21c, 21d are all different, and the curved surface equations are all different as well. This can increase the scattering of light passing through the optical sheet 2″, thereby making the light more uniform.

### Second Embodiment

With reference to FIG. 7, an optical sheet 3 according to a second embodiment of the invention includes a substrate 30, a plurality of convex lens structures 31, and at least a triangular prism structure 32. The first surface 301 and the second surface 302 of the substrate 30 are disposed opposite to each other. The material of the substrate 30 is the same as that of the first embodiment, so the detailed description will be omitted. The convex lens structures 31 are disposed on the second surface 302 and are positioned adjacent to the triangular prism structures 32. The height H3 of the triangular prism structure 32 is smaller than the height of the convex lens structures 31 so as to prevent the peak of the triangular prism structure 32 from breaking. It should be noted that the triangular prism structure 32 is used to increase the converging effect of the optical sheet 3. The ratio of the amount of the triangular prism structures 32 to that of the convex lens structures 31 in the optical sheet 3 can be adjusted according to needs. That is, more triangular prism structures 32 are configured for a stronger converging effect. Otherwise, more convex lens structures 31 are configured for a stronger diffusion effect. Moreover, the convex lens structures 31 and the triangular prism structures 32 are disposed in a periodic or non-periodic way.

### Third Embodiment

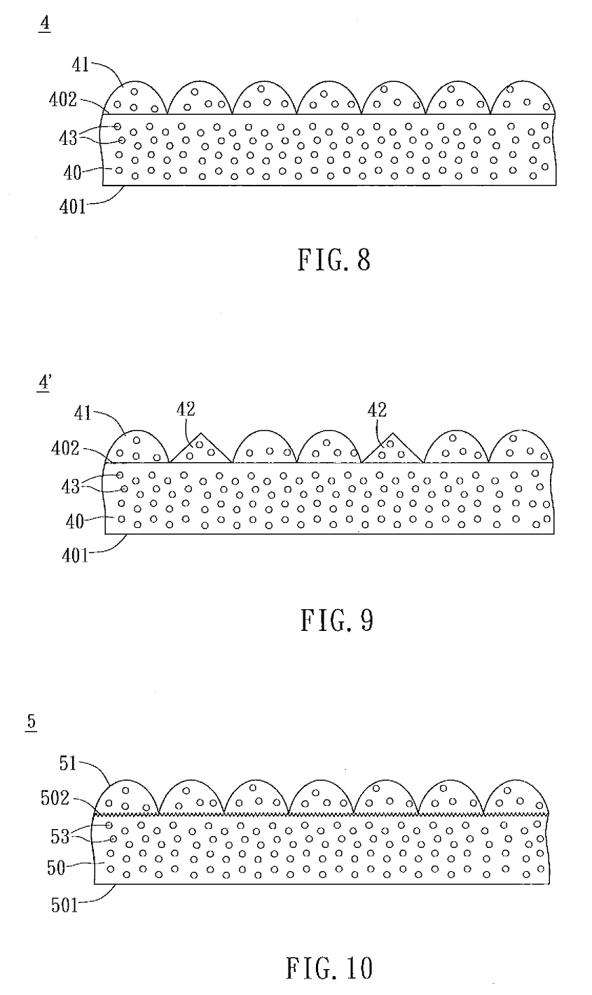

With reference to FIG. 8, an optical sheet 4 according to a third embodiment of the invention includes a substrate 40, a plurality of convex lens structures 41, and a diffusion material 43. The first surface 401 and the second surface 402 of the substrate 40 are disposed opposite to each other. The convex lens structures 41 are disposed on the second surface 402. The material of the substrate 40 is the same as that of the first embodiment, so the detailed description will be omitted. The diffusion material 43 can be disposed in the substrate 40 and/or the convex lens structures 41. In this embodiment, the diffusion material 43 is disposed in the substrate 40 and the convex lens structures 41 by, for example, doping. The diffusion material 43 consists of titanium dioxide or silicon dioxide diffusion particles or multiple layers of diffusion particles of different indices of refraction.

FIG. 9 shows another optical sheet 4′ according to the third embodiment of the invention. The difference between FIG. 9 and FIG. 8 is in that: the optical sheet 4′ further includes several triangular prism structures 42. The convex lens structures 41 and the triangular prism structures 42 are disposed adjacent to each other on the second surface 402. The diffusion material 43 is disposed in the substrate 40 and/or the convex lens structures 41 and/or the triangular prism structures 42. In this embodiment, the diffusion material 43 is disposed in the substrate 40, the convex lens structures 41, and the triangular prism structures 42 by doping. When the optical sheet 4′ is doped with the diffusion material 43, the passing light is strongly scattered and the cut off effect at large viewing angles is reduced.

### Fourth Embodiment

With reference to FIG. 10, an optical sheet 5 according to a fourth embodiment of the invention includes a substrate 50 and a plurality of convex lens structures 51. The substrate 50 has a first surface 501 and a second surface 502 disposed opposite to each other The material of the substrate 50 is the same as that of the first embodiment, so the detailed description will be omitted. The first surface 501 and/or the second surface 502 is a rough surface. In this embodiment, the second surface 502 is processed by an abrasive blasting processing or a chemical agent process so as to form a rough surface. Besides, the first surface 501 and/or the second surface 502 can be attached with a matte paper (not shown) to become a rough surface. The rough first surface 501 and second surface 502 of the optical sheet 5 can increase the light scattering and reduce the cut of effect at large viewing angles as well. Moreover, using the optical sheet 5 in the LCD device can greatly reduce the Moiré pattern.

In summary, the optical sheet of the invention has convex lens structures with cambered surfaces formed on the substrate. Compared with the prior art, the optical sheet achieves the effects of converging light to increase the central luminance as well as scattering light at large viewing angles. Such features avoid the cut off effect and large variation in the luminance from small to large viewing angles. The convex lens structures with cambered surfaces also render the optical sheet scratch-proof, thereby avoiding the problem of broken lens peaks.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. An optical lens, comprising:
a substrate, which has a first surface and a second surface disposed opposite to each other; and
a plurality of convex lens structures, which are disposed on the second surface, wherein each of the convex lens structures has a cambered surface satisfying a curved surface equation Ax²+By²+Cxy+Dx+Ey+F=0, where x and y are variables and A, B, C, D, E, and F are constants.

2. The optical sheet of claim 1, wherein A and B are not simultaneously zero.

3. The optical sheet of claim 1, wherein the convex lens structures are disposed in parallel.

4. The optical sheet of claim 1, wherein the height or width of the convex lens structures are the same or different.

5. The optical sheet of claim 1 further comprising:
at least one triangular prism structure disposed on the second surface and adjacent to one of the convex lens structures, wherein the height of the triangular prism structure is smaller than the height, of the convex lens structure.

6. The optical sheet of claim 1, wherein the curved surface equation represents an ellipse or a circle.

7. The optical sheet of claim 1 further comprising:
a diffusion material disposed in the substrate and/or the convex lens structures.

8. The optical sheet of claim 5 further comprising:
a diffusion material disposed in the substrate, the convex lens strictures and/or the triangular prism structure.

9. The optical sheet of claim 1, wherein the first surface and/or the second surface is a rough surface.

10. The optical sheet of claim 9, wherein the rough surface is formed by with an abrasive blasting processing or a chemical agent surface processing.

11. The optical sheet of claim 9, wherein the substrate further has a matte paper formed on the first surface and/or the second surface.
